(19) United States
(12) Patent Application Publication
(10) Pub. No.: US 2004/0049432 A1
(43) Pub. Date: Mar. 11, 2004

(54) Method for controlling access to a site

(76) Inventors: Gilles Beljakovic, Saint-Aubin (CH); Stephane Joly, Neuchatel (CH)

Correspondence Address: Piper Rudnick, Supervisor Patent Prosecution Services, 1200 Nineteenth Street NW, Washington, DC, 20036-2412, US

(21) Appl. No.: 10/432,896

(22) PCT Filed: Nov. 27, 2001
(86) PCT No.: PCT/IB01/02243

(30) Foreign Application Priority Data
Nov. 29, 2000 (CH) 2320/00

(51) Int. Cl. G06F 17/60

(52) U.S. Cl. 705/26

(57) ABSTRACT

The objective of the present invention is to propose a method to facilitate access to premises or an event. This objective is achieved by a subscription, payment, and access control method to a public event, of a user having an electronic payment means, comprising the following stages:

gaining access to a booking centre to book at least one ticket for an event and transmitting personal identification data,

identifying the user and memorising in the booking centre of the event and the identity of the user,

introduction of the payment means containing all or part of the personal identification data in a distributor connected to the booking centre,

reading the personal data and verifying the booking of said user,

printing of visual data authorising access to the event on the payment means,

presentation at the entrance of the event of said payment means to access the event.

A booking method by cards of the Metrocine type allows the spectator to print, by means of a work station connected to the Internet, the name of the film and the session in plaintext to facilitate him/her the access to the cinema.

The present invention concerns the field of conditional access of physical persons to private premises, particularly private premises whose access is subject to the surveillance or sporadic control of a physical person or of an apparatus for filtering tickets.

Conditional access systems to public amenities are known, premises that offer cultural or entertainment manifestations such as theatres, cinemas, or stadiums, systems where the spectator buys a prepayment support such as a card. This card generally contains a credit for a certain number of entries to the premises.

Although these systems of the Metrocine type offer the advantage of reducing the amount of cash exchanged when the spectators enter the premises, they only reduce the waiting time at the ticket offices in less measure. In fact, in most multiscreen cinemas the spectator still has to tell the cashier the name of the film he/she wants to see. Even though the decrementation of the credit present on the card takes less time than paying with cash, the holder of such a card still has to queue as if he/she paid in cash.

Furthermore, in this type of system of the Metrocine type, the client receives from the cashier a ticket mentioning the film or the cinema, as if he/she were a normal client. This waiting time can refrain a user from participating in this type of events, and the show industry is faced with losses linked to this phenomenon.

A procedure then is lacking that allows the spectator to book in advance on his/her prepayment support an identifier of the show he/she wants to see and to allow an easy access to the show.

This objective is totally achieved by a subscription, payment, and access control method to a public event of a user having a data support comprising the following stages:

gaining access to a booking centre to book at least one ticket for an event and transmitting these personal identification data,

identifying the user and memorising in the booking centre of the event and the identity of the user,

introduction of the data support containing all or part of the personal identification data in a distributor connected to the booking centre,

reading the personal data and verifying the booking of said user,

printing of visual data authorising access to the event on the data support,

presentation at the entrance of the event of said data support to access the event.

The data support has preferably a form of a card on which is printed the data of the concerned event. It can be a card whose data is stored in magnetic form, or a smart card.

The show or session identifier can consist of an index, coded for example in electronic form in a card belonging to the spectator or client.

Nevertheless, in a particular embodiment of the invention in which the cards have a graphic zone re-writeable for multiple erasures and re-writings, the identifier of the session can consist in the printing on the spectator's card of the title in plaintext of the session he/she has booked.

The advantage of this embodiment is that the spectator can appear a few moments before the beginning of the session, however long the queue is, and justify his/her booking and prepayment to access directly the private premises. Another advantage, during the first performance of a much expected show, such as a famous film, is to allow an early detection of the amount of seats occupied of the hall that is the private premises. The manager of this hall can thus ensure that the clients using this system will not be let down by the apparition of a panel “Sold Out” after they have spent a long time in the queue.

In this embodiment it is possible to offer these clients a semi-public terminal of the ATM type (Automatic Ticket Machine), for example near the ticket boxes of the cinema. The client validates his/her re-writeable card after having identified himself/herself by means of the database centralising the bookings made, for example from home with the Internet in the frame of this system. An advantage of placing the terminal near the boxes is that the speed of the transaction awakens the curiosity of the clients waiting in the queue to obtain their ticket, which contributes to the growing success of the system and of its other advantages.

In another embodiment of the invention, the user has the possibility of making a complete booking of the session from his/her home, notably but not exclusively by Internet, gaining access first to the Internet site of the private premises and then carrying out the booking according to the method of the invention. The booking centre transmits by means of the Internet a booking code that is charged on the user's card.

The client then inserts in a second time his/her prepayment support such as a zone card visually re-writeable in a distributor near the entrance of the event, this terminal being linked to the booking centre. The card reader writes on the prepayment support the identifier of the session the client has chosen to attend, under reserve of verification, by dialogue with the booking centre, that this session is not already complete and that the credit of the user is enough. In the case of a re-writeable card the unit writes in plaintext the name of the show such as a film, play, music-hall, or sporting event as well as the seat number.

According to an embodiment of the invention, the distributor inscribes on the payment support apart from the data relative to a show a non-foreseeable code exclusive of this show. This is to prevent people having such a writing unit from making false cards. This code is modified for each show, and the person in charge of the visual control of the tickets can rapidly detect for example three letters (for example AHT) more easily than the description of the show in plaintext. It is to be noted that this card can comprise a visual region that is not printable by the procedure of writing and that comprises a logotype impossible to falsify such as a hologram.

In parallel with the graphic data of the purchased show, data concerning this show are stored in a memory contained inside the payment support. In case of doubt in relation to the validity of the visual data of the card it is possible to verify with a reader these data which are placed in a secured region of the card.

In a completely automatic form of the invention these electronic data contained in the card allow the liberation of a turnstile to access the event.

Concerning the booking stage, it can be done also by telephone to a booking centre and the identification of the user is done by a password to the operating centre by the telephone operator such as the phone number.

Once in front of the distributor of entry tickets, the user's card whose use is linked to the password transmitted or to the user's phone number is introduced in the reader. The distributor requests from the booking centre the data linked to this user. After the verification operation the printing of the ticket can take place.

According to an embodiment called off-line, the booking centre returns to the user's card electronic data stored in the user's smart card and authorises the printing of the entry ticket to the event. During the presentation stage of the card to the distributor, the data contained in the card are recognised by the distributor and they start the printing of the entry ticket.

In a particular embodiment of the invention the printing of the card comprises the user's photograph. Thus, the access control can be applied to events in which a filtering of persons is desired. The card will then contain visually data describing the access to the event, the photograph of the authorised person and finally a non-foreseeable code whose validity can be limited, for example one day or the duration of the event.

1. A method of subscription, payment, and control of access to a public or private event, of a user having a data support, comprising the following stages:
gaining access to a booking centre to book at least one ticket for an event and transmitting personal identification data,
identifying the user and memorising in the booking centre of the event and the identity of the user,
introduction of the data support containing all or part of the personal identification data in a distributor connected to the booking centre,
reading the personal data and verifying the booking of said user,
printing of visual data authorising access to the event on the electronic data support,
presentation at the entrance of the event of said electronic data support to access the event.

2. A method according to claim 1, characterised in that the data support comprises a re-writeable electronic memory and in that the distributor writes information concerning the event in said memory.

3. A method according to claims 1 or 2, characterised in that the visual data printed on the data support comprise a non-foreseeable code exclusive of this event.

4. A method according to claims 1 to 3, characterised in that the visual data printed on the data support comprise a photograph of the authorised user.
